(19) United States
(12) Patent Application Publication
(10) Pub. No.: US 2026/0317601 A1
(43) Pub. Date: Oct. 15, 2026

(54) UV-CURABLE ADHESIVE COMPOSITION AND INTERIOR FILM COMPRISING ADHESIVE LAYER FORMED THEREOF

(71) Applicant: KCC GLASS Corporation, Seoul (KR)

(72) Inventors: Jeong-Hee LEE, Seoul (KR); Jangwook KIM, Yongin-si, Gyeonggi-do (KR); Sung-Ha SEO, Gunpo-si, Gyeonggi-do (KR); Byung-Young JUNG, Yongin-si, Gyeonggi-do (KR)

(21) Appl. No.: 19/483,242

(22) PCT Filed: Apr. 30, 2024
(86) PCT No.: PCT/KR2024/005891

§ 371 Date: Nov. 11, 2025

(30) Foreign Application Priority Data
Jun. 15, 2023 (KR) 10-2023-0077002

(51) Int. Cl. C09J 175/14; B32B 7/12; B32B 27/08; B32B 27/30; C08F 283/00

(52) U.S. Cl. CPC C09J 175/14; B32B 7/12; B32B 27/08; B32B 27/304; B32B 2250/24; B32B 2255/10; B32B 2255/26; B32B 2307/412; B32B 2307/75; B32B 2451/00; C08F 283/008

(57) ABSTRACT

The present invention relates to a UV-curable adhesive composition and an interior film comprising same, wherein the UV-curable adhesive composition comprises: a urethane (meth)acrylate-based oligomer; a (meth)acrylate-based monomer; a caprolactam-based compound; and a UV initiator, wherein the urethane (meth)acrylate-based oligomer includes two functional groups, and has a weight average molecular weight of 500 g/mol to 2,000 g/mol.

### TECHNICAL FIELD

This application claims the benefit of Korean Patent Application No. 10-2023-0077002, filed on Jun. 15, 2023, in the Korean Intellectual Property Office, the disclosure of which is incorporated herein in its entirety by reference.

The present invention relates to an ultraviolet-curable adhesive composition having excellent storage stability at room temperature (25° C.) and a high temperature (60° C.), and excellent adhesion to an ink layer, and an interior film including an adhesive layer formed therefrom, thereby having excellent adhesion and durability between an ink layer and a transparent protective layer.

### BACKGROUND ART

As a method for applying a specific color to various types of substrates or forming patterns, various printing methods such as flexo printing, gravure printing, inkjet printing, and screen printing have been used. Particularly, gravure printing and flexo printing have been widely used since they allow for mass production at high speeds. However, there have been limitations in that gravure printing and flexo printing incur additional costs and time for manufacturing of copper plates, etc., for a design change, and the resolution of images after printing is not sufficient. In addition, in a typical printing method, a solvent-type ink including an organic solvent is commonly used, and the solvent-type ink includes the organic solvent in the ink, and thus, releases a large amount of a volatile organic compound (VOC), thereby causing an environmental problem.

As an alternative to the above, digital printer printing and the use of water-based inks have been proposed. If a digital printer printing method is used, for example, a laminate body may be prepared by printing an ink layer on a base layer by using a digital printer, forming an adhesive layer on the ink layer, and then laminating and curing a transparent protective layer on the adhesive layer. Specifically, Japanese Patent Registration No. 5945902 (Patent Document 1) discloses an ink composition for inkjet printing, which includes at least one among a pigment, a water-soluble organic solvent, a surfactant, a urethane (meth)acrylate having a weight average molecular weight of 1,000 to 10,000, and a cross-linked urethane (meth)acrylate having a constituent unit including the urethane (meth)acrylate, a compound having a radical-polymerizable group, a photo-radical polymerization initiator, and water.

If the above-described digital printer printing method is used, adhesion between the ink layer and the transparent protective layer should be excellent so as not to allow the transparent protective layer to be peeled off, and there should be no issues such as reduced printability due to a difference in surface tension between the ink layer and the adhesive.

Therefore, there is a need for the research and development on an adhesive composition which has excellent adhesion to a printed ink layer, improves the adhesion between an ink layer and a transparent protective layer, and thus may prevent peeling of the transparent protective layer, and is applicable to a digital printing method.

### DISCLOSURE OF THE INVENTION

### Technical Problem

The present invention is to provide an adhesive composition which has excellent adhesion to a printed ink layer, improves the adhesion between an ink layer and a transparent protective layer, and thus, may prevent peeling of the transparent protective layer, and is applicable to a digital printing method, and furthermore, has excellent storage stability at room temperature (25° C.) and a high temperature (60° C.), so that an adhesive layer prepared therefrom has excellent adhesion even after storage.

In addition, the present invention is to provide an interior film including an adhesive layer formed from the adhesive composition, and thus has decreased appearance defects such as cracks, has excellent flexibility, and thus has reduced cracks even when folded, thereby having excellent durability, and furthermore, has excellent coating properties to an ink layer.

### Technical Solution

The present invention provides an ultraviolet-curable adhesive composition including a urethane (meth)acrylate-based oligomer, a (meth)acrylate-based monomer, a caprolactam-based compound, and an ultraviolet initiator,

wherein the urethane (meth)acrylate-based oligomer includes two functional groups, and has a weight average molecular weight of 500 g/mol to 2,000 g/mol.

In addition, the present invention provides an interior film including a base layer;

an ink layer formed on the base layer, an adhesive layer formed on the ink layer;

and formed from the ultraviolet-curable adhesive composition; and

a transparent protective layer formed on the adhesive film.

### Advantageous Effects

An ultraviolet-curable adhesive composition according to the present invention has excellent storage stability at room temperature (25° C.) and a high temperature (60° C.), and has excellent adhesion to a printed ink layer.

In addition, an adhesive layer formed from the adhesive composition according to the present invention improves the adhesion between an ink layer and a transparent protective layer, and thus may prevent peeling of the transparent protective layer, thereby having excellent interlayer adhesion and excellent product reliability. Furthermore, an interior film including the adhesive layer according to the present invention has decreased appearance defects such as cracks, and has excellent flexibility, and thus has reduced cracks even when folded, thereby having excellent durability. In addition, the adhesive layer formed from the adhesive composition in the interior film according to the present invention has excellent coating properties to an ink layer.

### Best Mdoe for Carrying Out the Invention

Hereinafter, the present invention will be described in detail.

In the present specification, when a portion is said to “include” any component, it means that the portion may further include another component rather than excluding the another component unless otherwise stated.

In addition, in the present specification, when a layer is said to be positioned “on” another layer, it includes not only a case in which the layer is in contact with the another layer, but also a case in which yet another layer is present between the two layers.

A “weight average molecular weight” may be measured by a method well known in the art, and may represent a value measured by, for example, a method of gel permeation chromatograph (GPC).

A “particle size,” which is the diameter of a particle, is measured by a typical method known in the art, and may be measured by, for example, laser light scattering (LLS), and an “average particle size” may be an average value of particle diameters of 10% (D₁₀) to 90% (D₉₀) of cumulative distribution in the distribution of particle sizes as measured as described above.

In addition, a “viscosity” is measured by a typical method known in the art, and may be measured by, for example, using a Brookfield viscometer (rotational spindle viscometer).

A “functional group” is a functional group involved in a polymerization reaction, and may be, for example, a (meth)acrylate group, and “(meth)acrylate” means “acrylate” and/or “methacrylate.”

### Ultraviolet-Curable Adhesive Composition

An ultraviolet-curable adhesive composition according to the present invention includes a urethane (meth)acrylate-based oligomer, a (meth)acrylate-based monomer, a caprolactam-based compound, and an ultraviolet initiator.

### Urethane(Meth)Acrylate-Based Oligomer

A urethane (meth)acrylate-based oligomer is a main raw material governing the physical properties of an adhesive composition, and serves to impart adhesive strength to an adhesive layer prepared from a composition including the same. Specifically, the urethane (meth)acrylate-based oligomer includes a urethane structure having a soft polymer property, thereby improving melting and adhesive properties of the adhesive composition, and thus has excellent adhesion to an ink layer and a transparent protective layer, and has an effect of improving the flexibility and elongation of a product such as a manufactured interior film.

The urethane (meth)acrylate-based oligomer includes two functional groups. If the urethane (meth)acrylate-based oligomer includes two functional groups, the flexibility of a prepared adhesive layer, and the adhesion thereof to an ink layer and a transparent protective layer are excellent, so that there is an effect in that the interior film may be commercialized. Meanwhile, if the urethane (meth)acrylate-based oligomer includes one functional group, the adhesive composition lacks curing properties, which may result in uncuring of the adhesive layer and degradation in the adhesion thereof, and if the urethane (meth)acrylate-based oligomer includes three or more functional groups, the interior film has increased hardness, and thus may be cracked when the film is folded or embossed, which may cause damage to the film.

In addition, the urethane (meth)acrylate-based oligomer has a weight average molecular weight (Mw) of 500 g/mol to 2,000 g/mol. If the weight average molecular weight of a urethane (meth)acrylate-based oligomer is within the above-described range, there is an effect in that the adhesion between an ink layer and an adhesive layer is excellent during digital printing.

Specifically, the urethane (meth)acrylate-based oligomer may have a weight average molecular weight of 700 g/mol to 1,700 g/mol, or 1,000 g/mol to 1,500 g/mol. if the weight average molecular weight of the urethane (meth)acrylate-based oligomer is less than the above-described range, the adhesive composition may be uncured or may have degraded adhesion, and if greater than the above-described range, the adhesive layer has increased hardness, so that an interior film including the same may be cracked when folded or during an embossing process.

The urethane (meth)acrylate-based oligomer may have a viscosity at 25° C. of 1,000 cps to 5,000 cps, 2,000 cps to 4,800 cps, or 3,000 cps to 4,500 cps. If the viscosity at 25° C. of the urethane (meth)acrylate-based oligomer is less than the above-described range, there is a problem in that the adhesion of a prepared adhesive layer is insufficient, and if greater than the above-described range, the viscosity of the adhesive composition increases, which may result in insufficient workability.

In addition, the urethane (meth)acrylate-based oligomer may be included in an amount of 25 wt % to 40 wt %, 27 wt % to 38 wt %, or 29 wt % to 37 wt % based on the total weight of the adhesive composition. If the content of the urethane (meth)acrylate-based oligomer is less than the above-described range, there is a problem in that the adhesion of a prepared adhesive layer is insufficient due to an insufficient content of active ingredients in the adhesive composition, and if greater than the above-described range, an effect (improvement in adhesion) obtainable with respect to the amount of the urethane (meth)acrylate-based oligomer used is insufficient, which may reduce economic feasibility.

### (Meth)Acrylate-Based Monomer

A (meth)acrylate-based monomer serves to adjust the viscosity of an adhesive composition to improve workability, and to improve the adhesive strength of an adhesive layer prepared therefrom.

Specifically, the (meth)acrylate-based monomer may be a monofunctional monomer including one functional group. If the (meth)acrylate-based monomer includes one functional group, the prepared adhesive layer is flexible, so that there is an advantage in that the problem of cracks generated from the use of an interior film is prevented, and that the interior film may be stretched by heating.

Meanwhile, if the (meth)acrylate-based monomer is bifunctional or more including two or more functional groups, the adhesive layer has increased hardness, which may degrade the flexibility of an interior film, cause cracks during an embossing process, make it impossible to stretch the film during the film installation, or cause cracks when folding the film.

In this case, the functional group may include a (meth)acrylate group.

In addition, the (meth)acrylate-based monomer may include a first (meth)acrylate-based monomer containing a heterocycle group and a second (meth)acrylate-based monomer containing an aryl group.

The first (meth)acrylate-based monomer serves to improve the adhesive strength of an adhesive layer when manufacturing an interior film. For example, the first (meth)acrylate-based monomer may be tetrahydrofurfuryl acrylate (THFA).

The second (meth)acrylate-based monomer serves to suitably adjust the viscosity of the adhesive composition and to improve the solubility of an ultraviolet initiator. For example, the second (meth)acrylate-based monomer may be phenoxyethyl acrylate (PHEA).

The (meth)acrylate-based monomer may have a weight average molecular weight of 100 g/mol to 1,000 g/mol, 100 g/mol to 700 g/mol, or 100 g/mol to 500 g/mol. If the weight average molecular weight of the (meth)acrylate-based monomer is less than the above-described range, the adhesive strength of a prepared adhesive layer may be insufficient, and if greater than the above-described range, the adhesive layer has increased hardness, and thus may have insufficient flexibility.

In addition, the (meth)acrylate-based monomer may include the first (meth)acrylate-based monomer and the second (meth)acrylate-based monomer in a weight ratio of 1:0.5 to 1:2.0, a weight ratio of 1:0.6 to 1:1.5, or a weight ratio of 1:0.7 to 1:1.3.

If the (meth)acrylate-based monomer includes the second (meth)acrylate-based monomer in a small amount compared to the above-described range with respect to the first (meth)acrylate-based monomer, an ultraviolet initiator dissolution problem may occur. In addition, if the (meth)acrylate-based monomer includes the second (meth)acrylate-based monomer in an excessive amount compared to the above-described range with respect to the first (meth)acrylate-based monomer, the adhesive strength of a prepared adhesive layer may be degraded.

In addition, the (meth)acrylate-based monomer may be included in an amount of 40 wt % to 60 wt %, or 40 wt % to 56 wt % based on the total weight of the adhesive composition. If the content of the (meth)acrylate-based monomer is less than the above-described range, the adhesive composition has increased viscosity, so that the adhesive composition may have reduced coating workability, and if greater than the above-described range, the adhesive strength of an adhesive layer may be degraded due to a decrease in the viscosity of the adhesive composition or a decrease in the oligomer content.

Specifically, the adhesive composition may include 20 wt % to 30 wt %, 20 wt % to 28 wt %, or 22 wt % to 28 wt % of the first (meth)acrylate-based monomer, and 20 wt % to 30 wt %, 20 wt % to 28 wt %, or 22 wt % to 28 wt % of the second (meth)acrylate-based monomer, based on the total weight of the adhesive composition. If the content of the first (meth)acrylate-based monomer is out of the above-described range, the adhesion between an ink layer and an adhesive layer may be degraded during digital printing. In addition, when the content of the second (meth)acrylate-based monomer is less than the above-described range, an ultraviolet initiator dissolution problem may occur, and if greater than the above-described range, the viscosity of the adhesive composition may decrease or the adhesive strength of a prepared adhesive layer may be degraded.

In addition, the adhesive composition may include a urethane (meth)acrylate-based oligomer and a (meth)acrylate-based monomer in a weight ratio of 1:0.5 to 1:2.0, or 1:0.9 to 1:1.7. If the adhesive composition includes the (meth)acrylate-based monomer in a small amount compared to the above-described range based on the content of the urethane (meth)acrylate-based oligomer, the content of the (meth)acrylate-based monomer is insufficient, so that the viscosity of the adhesive composition is high, which may degrade workability. In addition, if the adhesive composition includes the (meth)acrylate-based monomer in an excessive amount compared to the above-described range based on the content of the urethane (meth)acrylate-based oligomer, the content of the urethane (meth)acrylate-based monomer is relatively insufficient, so that the viscosity of a prepared adhesive layer may be degraded.

### Caprolactam-Based Compound

A caprolactam-based compound serves to improve adhesion to an ink layer when preparing an adhesive layer by using an adhesive composition, and to improve heat resistance of the prepared adhesive layer.

The caprolactam-based compound may have a weight average molecular weight of 50 g/mol to 500 g/mol, 80 g/mol to 400 g/mol, or 100 g/mol to 300 g/mol. If the weight average molecular weight of the caprolactam-based compound is less than the above-described range, the adhesion and heat resistance of the prepared adhesive layer may be degraded, and if greater than the above-described range, the color of an ink layer may change during digital printing, and an effect of improving performance with respect to the amount of the caprolactam-based compound used is insufficient, which may reduce economic feasibility.

In addition, the caprolactam-based compound may be, for example, n-vinylcaprolactam.

The caprolactam-based compound may be included in an amount of 10 wt % to 20 wt %, or 10 wt % to 18 wt % based on the total weight of the adhesive composition. If the content of the caprolactam-based compound is less than the above-described range, the adhesive layer may have degraded adhesion, and the adhesive layer has weak heat resistance, which may cause a problem in that the color of a film changes during an interior film lamination process, and if greater than the above-described range, an ink layer may undergo an intrinsic color change during digital printing, or the adhesive layer may be overcured, and an effect of enhancing performance with respect to the amount of the caprolactam-based compound used is insufficient, which may not be preferable in terms of economic feasibility.

In addition, the adhesive composition may include the urethane (meth)acrylate-based oligomer and the caprolactam-based compound in a weight ratio of 1:0.2 to 1:1.0, or 1:0.25 to 1:0.70. If the adhesive composition includes the caprolactam-based compound in a small amount compared to the above-described range based on the content of the urethane (meth)acrylate-based oligomer, the adhesion of a prepared adhesive layer may be degraded, and the adhesive layer has weak heat resistance, which may cause a problem in that the color of a film changes during an interior film lamination process, In addition, if the adhesive composition includes the caprolactam-based compound in an excessive amount compared to the above-described range based on the content of the urethane (meth)acrylate-based oligomer, an ink layer may undergo an intrinsic color change during digital printing, or the adhesive layer may be overcured, and an effect of improving performance with respect to the amount of the caprolactam-based compound used is insufficient, which is not preferable in terms of economic feasibility.

### UV Initiator

An ultraviolet initiator absorbs ultraviolet rays, thereby initiating polymerization to cure an adhesive composition, and thus serves to form an adhesive layer and to control the curing rate of the adhesive composition.

The ultraviolet initiator may include an acyl group-containing phosphine oxide-based compound. Specifically, the ultraviolet initiator may be an acyl group-containing phosphine oxide-based compound.

For example, the acyl group-containing phosphine oxide-based compound may be a diphenyl(2,4,6-trimethylbenzoyl)phosphine oxide (TPO).

The ultraviolet initiator may be included in an amount of 2 wt % to 6 wt %, or 3 wt % to 5 wt % based on the total weight of the adhesive composition. If the content of the ultraviolet initiator is less than the above-described range, there may be a problem in that an adhesive layer is not cured, and if greater than the above-described range, there may be a problem in that an excessive amount of the ultraviolet initiator is not dissolved.

### Additive

The ultraviolet-curable adhesive composition may further include an additive such as a surface tension modifier, a surfactant, a preservative, and the like, and may also include an additive commonly applicable to an adhesive.

As an example, the surface tension modifier serves to control the wetting of a prepared adhesive layer, thereby decreasing a difference in surface tension between an ink layer and the adhesive layer to improve coating properties. Specifically, the surface tension modifier may be polyether-modified polydimethylsiloxane.

The surface tension modifier may be included in an amount of 0.5 wt % to 2.0 wt %, or 0.8 wt % to 1.5 wt % based on the total weight of the adhesive composition. If the content of the surface tension modifier is out of the above-described range, an agglomeration phenomenon may occur when applying the adhesive layer due to a difference in surface tension between the ink layer and the adhesive layer during digital printing.

The ultraviolet-curable adhesive composition may have a viscosity at 25° C. of 40 cps to 90 cps, or 50 cps to 80 cps.

The ultraviolet-curable adhesive composition according to the present invention as described above has excellent storage stability at room temperature (25° C.) and a high temperature (60° C.), and has excellent adhesion to a printed ink layer.

### Interior Film

In addition, an interior film according to the present invention includes a base layer, an ink layer formed on the base layer, and an adhesive layer formed on the ink layer, and formed from the ultraviolet-curable adhesive composition, and a transparent protective layer formed on the adhesive layer.

### Base Layer

The base layer may be used without any particular limitation as long as it is typically applicable to an interior film or a decorative film, and may include, for example, a vinyl chloride-based resin.

The vinyl chloride-based resin may be one or more selected from the group consisting of polyvinyl chloride (PVC), polyvinylidene chloride (PVDC), and vinyl chloride, and a vinyl chloride-based copolymer containing a monomer copolymerized therewith.

The base layer may use a commercially available product typically applicable to an interior film or a decorative film, and may have, for example, an average thickness of 30 μm to 200 μm, or 50 μm to 150 μm.

### Ink Layer

The ink layer may be used without any particular limitation as long as it is an ink composition typically applicable to an interior film or a decorative film.

The ink layer may be formed by a digital printing method. For example, the ink layer may be formed by printing an ink composition on a base layer by a digital printing method.

Specifically, the ink composition may include an oligomer, a monomer, an ultraviolet initiator, and the like.

### Adhesive Layer

The adhesive layer is formed from the ultraviolet-curable adhesive composition as described above. The adhesive layer according to the present invention has excellent adhesion to an ink layer, and has an effect of preventing interlayer peeling by imparting excellent adhesion between the ink layer and a transparent protective layer.

The adhesive layer may be applied without particular limitation as long as the adhesive layer has a thickness typically applicable to an interior film or a decorative film, and may have an average thickness of, for example, 1 μm to 20 μm or 2 μm to 10 μm. If the average thickness of the adhesive layer is out of the above-described range, the adhesion between the ink layer and the transparent protective layer weakens, which may cause interlayer peeling, or a thick adhesive layer may adversely affect the color development of the ink layer.

### Transparent Protective Layer

The protective layer may be used without any particular limitation as long as it is typically applicable to an interior film or a decorative film, and may include, for example, a vinyl chloride-based resin.

The vinyl chloride-based resin may be one or more selected from the group consisting of polyvinyl chloride (PVC), polyvinylidene chloride (PVDC), and vinyl chloride, and a vinyl chloride-based copolymer containing a monomer copolymerized therewith.

The transparent protective layer may be formed by a method typically applicable to an interior film or a decorative film, and may be formed by, for example, a method of performing lamination on the adhesive layer and then performing curing by irradiation with ultraviolet rays.

In addition, the transparent protective layer may use a commercially available product typically applicable to an interior film or a decorative film, and may have, for example, an average thickness of 50 μm to 200 μm, or 80 μm to 130 μm. If the average thickness of the transparent protective layer is out of the above-described range, an effect of deep embossing is not implemented, resulting in poor texture, or the film price increases due to a thick thickness, which may reduce economic feasibility.

The interior film may have a 180° peel strength of 4.0 kgf/inch or greater, 4.0 kgf/inch to 6.0 kgf/inch, or 4.5 kgf/inch to 5.5 kgf/inch between the ink layer and the transparent protective layer, which is measured by using a tensile tester.

The interior film according to the present invention as described above has excellent adhesion between the ink layer and the transparent protective layer, and thus may prevent peeling of the transparent protective layer, thereby having excellent interlayer adhesion and excellent product reliability. In addition, the interior film according to the present invention has decreased appearance defects such as cracks, and has excellent flexibility, and thus has reduced cracks even when folded, thereby having excellent durability.

Hereinafter, the present invention will be described in more detail with reference to examples.

### Mdoe for Carrying Out the Invention

### EXAMPLES

### Experimental Examples 1 to 18. Preparation of Ultraviolet-Curable Adhesive Composition

A ultraviolet-curable adhesive composition was prepared by adjusting the composition as described in Tables 1 to 3.

TABLE 1

| Component | Experimental | Experimental | Experimental | Experimental | Experimental | Experimental |
|---|---|---|---|---|---|---|
| (wt %) | Example 1 | Example 2 | Example 3 | Example 4 | Example 5 | Example 6 |
| Oligomer 1 | 30.0 | 33.0 | 35.0 | | 30.0 | 30.0 |
| Oligomer 2 | | | | 30.0 | | |
| Oligomer 3 | | | | | | |
| Oligomer 4 | | | | | | |
| Oligomer 5 | | | | | | |
| Monomer 1 | 25.0 | 25.0 | 25.0 | 25.0 | 22.0 | 28.0 |
| Monomer 2 | 25.0 | 25.0 | 25.0 | 25.0 | 28.0 | 22.0 |
| Monomer 3 | | | | | | |
| Monomer 4 | | | | | | |
| Monomer 5 | | | | | | |
| Caprolactam- | 15.0 | 12.0 | 10.0 | 15.0 | 15.0 | 15.0 |
| based | | | | | | |
| compound | | | | | | |
| UV initiator | 4.0 | 4.0 | 4.0 | 4.0 | 4.0 | 4.0 |
| Surface | 1.0 | 1.0 | 1.0 | 1.0 | 1.0 | 1.0 |
| tension | | | | | | |
| modifier | | | | | | |
| Total sum | 100.0 | 100.0 | 100.0 | 100.0 | 100.0 | 100.0 |

TABLE 2

| Component | Experimental | Experimental | Experimental | Experimental | Experimental | Experimental |
|---|---|---|---|---|---|---|
| (wt %) | Example 7 | Example 8 | Example 9 | Example 10 | Example 11 | Example 12 |
| Oligomer 1 | 37.0 | | | | 30.0 | 30.0 |
| Oligomer 2 | | | | | | |
| Oligomer 3 | | 30.0 | | | | |
| Oligomer 4 | | | 30.0 | | | |
| Oligomer 5 | | | | 30.0 | | |
| Monomer 1 | 20.0 | 25.0 | 25.0 | 25.0 | 25.0 | 25.0 |
| Monomer 2 | 20.0 | 25.0 | 25.0 | 25.0 | | |
| Monomer 3 | | | | | 25.0 | |
| Monomer 4 | | | | | | 25.0 |
| Monomer 5 | | | | | | |
| Caprolactam- | 18.0 | 15.0 | 15.0 | 15.0 | 15.0 | 15.0 |
| based compound | | | | | | |
| UV initiator | 4.0 | 4.0 | 4.0 | 4.0 | 4.0 | 4.0 |
| Surface | 1.0 | 1.0 | 1.0 | 1.0 | 1.0 | 1.0 |
| tension | | | | | | |
| modifier | | | | | | |
| Total sum | 100.0 | 100.0 | 100.0 | 100.0 | 100.0 | 100.0 |

TABLE 3

| Component | Experimental | Experimental | Experimental | Experimental | Experimental | Experimental |
|---|---|---|---|---|---|---|
| (wt %) | Example 13 | Example 14 | Example 15 | Example 16 | Example 17 | Example 18 |
| Oligomer 1 | 30.0 | 22.0 | 37.0 | | 45.0 | 33.0 |
| Oligomer 2 | | | | | | |
| Oligomer 3 | | | | | | |
| Oligomer 4 | | | | | | |
| Oligomer 5 | | | | | | |
| Monomer 1 | 25.0 | 50.0 | 50.0 | 25.0 | 25.0 | 29.0 |
| Monomer 2 | | | | 25.0 | 25.0 | 29.0 |
| Monomer 3 | | | | | | |
| Monomer 4 | | | | 30.0 | | |
| Monomer 5 | 25.0 | | | | | |
| Caprolactam- | 15.0 | 23.0 | 8.0 | 15.0 | | 5.0 |
| based compound | | | | | | |
| UV initiator | 4.0 | 4.0 | 4.0 | 4.0 | 4.0 | 4.0 |
| Surface tension | 1.0 | 1.0 | 1.0 | 1.0 | 1.0 | |
| modifier | | | | | | |
| Total sum | 100.0 | 100.0 | 100.0 | 100.0 | 100.0 | 100.0 |

The manufacturer, product name, and other properties of each component used in Experimental Examples above are shown in Table 4 below, and Mw is a weight average molecular weight.

TABLE 4

| Component | Notes |
|---|---|
| Oligomer 1 | Bifunctional urethane acrylate oligomer (Mw 1,000 g/mol, viscosity |
| | (25° C.) 3,550 cps) |
| Oligomer 2 | Bifunctional urethane acrylate oligomer (Mw 1,500 g/mol, viscosity |
| | (25° C.) 4,470 cps) |
| Oligomer 3 | Monofunctional urethane acrylate oligomer (Mw 440 g/mol, viscosity |
| | (25° C.) 910 cps) |
| Oligomer 4 | Bifunctional urethane acrylate oligomer (Mw 3,700 g/mol, viscosity |
| | (25° C.) 7,630 cps) |
| Oligomer 5 | Trifunctional epoxy acrylate oligomer (Mw 1,800 g/mol, viscosity |
| | (25° C.) 4,830 cps) |
| Monomer 1 | Monofunctional monomer (tetrahydrofurfuryl methacrylate, THFA) |
| Monomer 2 | Monofunctional monomer (phenoxyethyl acrylate, PHEA) |
| Monomer 3 | Bifunctional monomer (1,6-hexanediol diacrylate, HDDA) |
| Monomer 4 | Trifunctional monomer (ethoxylated trimethylolpropane triacrylate, |
| | ETPTA) |
| Monomer 5 | Tetrafunctional monomer (Pentaerythritol tetraacrylate, PETA) |
| Caprolactam- | N-vinylcaprolactam (NVC) |
| based compound | |
| UV initiator | Diphenyl(2,4,6-trimethylbenzoyl)phosphine oxide |
| Surface tension | Polyether modified polydimethylsiloxane (Product name: BYK-UV3510) |
| modifier | |

### Test Example: Evaluation of Properties

Physical properties of an ultraviolet-curable adhesive composition of Test Example were measured by the following methods, and the results are shown in Table 5.

### (1) Viscosity of at 25° C.

It was measured at room temperature (25° C.) by using a viscometer (Brookfield spindle viscometer, Brookfield Viscometer LVDV-II, CPE-40 spindle).

(2) Generation of Cracks after being Folded 360°

On a colored PVC film (manufacturer: Geumgang Enterprise, product name: KKP PRINT, thickness: 80 μm), an ink layer was formed by using a 1024i series of KONNIKA Corporation and a digital printing device equipped with a RICHO GEN5 head, and using ANUVIA 1550 ink of AGFA Corporation. Thereafter, an ultraviolet-curable adhesive composition of Experimental Example was applied to about 7 μm on the ink layer to form an adhesive layer. Thereafter, a PVC transparent film (manufacturer: Geumgang Enterprise, product name: KKP DECO, thickness: 110 μm) was laminated on the adhesive layer, and irradiated with ultraviolet rays as an LED light source having a wavelength of 395 nm to prepare a specimen.

The specimen in which the colored PVC film, the ink layer, the adhesive layer, and the PVC transparent film were sequentially laminated in that order was stored at 25° C. or −20° C. for 24 hours, and then the specimen was folded 360° to visually confirm whether there was a crack.

### (3) Generation of Cracks

A specimen was prepared in the same manner as in Item (2), and then the specimen was passed through a roll made of SUS and having a depth of 200 μm at 170° C. under a pressure of 6 MPa to create an embossing texture. Thereafter, it was visually confirmed whether a printed surface was intact in a portion pressed to a depth of 200 μm.

### (4) Coating Suitability for Ink Layer

An ink layer was formed on a colored PVC film (manufacturer: Geumgang Enterprise, product name: KKP PRINT, thickness: 80 μm) by using a 1024i series of KONNIKA Corporation and a digital printing device equipped with a RICHO GEN5 head, and using a UV ink composition (manufacturer: AGFA, product name: ANUVIA 1550). Thereafter, the ultraviolet-curable adhesive composition of Experimental Example was applied to a thickness of about 7 μm on the ink layer to form an adhesive layer, and it was visually confirmed whether the surface of the adhesive layer was uniformly applied over time. It was determined as defective if beading (clumping in a water droplet shape) was formed within 5 minutes after the application, and as good if the coated surface maintained a uniformly applied state without beading.

### (5) Peel Strength

A specimen was prepared in the same manner as in Item (2), and the prepared specimen in which the colored PVC film, the ink layer, the adhesive layer, and the PVC transparent film were sequentially laminated in that order was stored at 25° C. for 1 day, and then 180° peel strength between the ink layer and the PVC transparent film was measured for the specimen by using a tensile tester (Universal Testing Machine, manufacturer: SALT, model name: ST-1003).

(6) Peel Strength after Storage

A specimen was prepared in the same manner as in Item (2), and then stored at 60° C. or −20° C. for 2 weeks, and the peel strength was measured in the same manner as in Item (5).

TABLE 5

| | | Generation of | | Generation | | | Peel strength | |
|---|---|---|---|---|---|---|---|---|
| | Viscosity | cracks after | | of cracks | | Peel | after storage | |
| | (25° C.) | being folded | | (200 μm | Coating | strength | (kgf/inch) | |
| | (cps) | 25° C. | −20° C. | embossing) | suitability | (kgf/inch) | 60° C. | −20° C. |
| Experimental | 51 | X | X | X | Good | 5.3 | 5.1 | 5.4 |
| Example 1 | | | | | | | | |
| Experimental | 60 | X | X | X | Good | 5.2 | 5.0 | 5.3 |
| Example 2 | | | | | | | | |
| Experimental | 71 | X | X | X | Good | 4.9 | 4.8 | 5.1 |
| Example 3 | | | | | | | | |
| Experimental | 62 | X | X | X | Good | 5.0 | 5.1 | 5.3 |
| Example 4 | | | | | | | | |
| Experimental | 52 | X | X | X | Good | 4.9 | 5.3 | 5.1 |
| Example 5 | | | | | | | | |
| Experimental | 53 | X | X | X | Good | 5.4 | 5.5 | 5.1 |
| Example 6 | | | | | | | | |
| Experimental | 75 | X | X | X | Good | 5.3 | 5.8 | 5.1 |
| Example 7 | | | | | | | | |
| Experimental | 48 | X | X | X | Good | 2.1 | 2.0 | 2.6 |
| Example 8 | | | | | | | | |
| Experimental | 106 | X | X | X | Poor | 5.1 | 5.3 | 5.1 |
| Example 9 | | | | | | | | |
| Experimental | 72 | ◯ | ◯ | ◯ | Good | 5.6 | 5.1 | 5.2 |
| Example 10 | | | | | | | | |
| Experimental | 60 | X | X | ◯ | Good | 4.3 | 4.3 | 4.5 |
| Example 11 | | | | | | | | |
| Experimental | 62 | X | ◯ | ◯ | Good | 4.6 | 4.6 | 4.8 |
| Example 12 | | | | | | | | |
| Experimental | 78 | ◯ | ◯ | ◯ | Good | 4.1 | 4.2 | 4.9 |
| Example 13 | | | | | | | | |
| Experimental | 51 | X | X | X | Good | 2.8 | 2.7 | 2.7 |
| Example 14 | | | | | | | | |
| Experimental | 78 | X | X | X | Good | 4.2 | 3.4 | 4.6 |
| Example 15 | | | | | | | | |
| Experimental | 28 | X | X | ◯ | Good | 1.1 | 1.2 | 1.0 |
| Example 16 | | | | | | | | |
| Experimental | 102 | X | X | X | Poor | 4.6 | 3.7 | 4.8 |
| Example 17 | | | | | | | | |
| Experimental | 75 | X | X | X | Poor | 3.5 | 3.4 | 3.7 |
| Example 18 | | | | | | | | |

As shown in Table 5, the compositions of Experimental Examples 1 to 7 had a suitable viscosity at 25° C., and thus, had excellent workability, and the adhesive layers prepared therefrom were not cracked, and were not cracked even by folding, had excellent coating suitability for the ink layer, and had excellent peel strength, and excellent peel strength even after storage.

On the other hand, Experimental Example 8 including Oligomer 3 including a monofunctional urethane acrylate oligomer, Experimental Example 14 including a small amount of a urethane acrylate oligomer and an excessive amount of a caprolactam-based compound, Experimental Example 16 not including a urethane acrylate oligomer, and Experimental Example 18 including a small amount of a caprolactam-based compound had insufficient peel strength and peel strength after storage. Particularly, Experimental Example 16 had low viscosity of the composition, and thus had insufficient workability and had cracks in the cured product. In addition, Experimental Example 18 had insufficient coating suitability of the ink layer.

In addition, Experimental Example 9 including Oligomer 4, which is a bifunctional urethane acrylate oligomer having a high viscosity at 25° C. and a high weight average molecular weight, and Experimental Example 17 including an excessive amount of a urethane acrylate oligomer and not including a caprolactam-based compound had high viscosity of the adhesive composition, and thus had insufficient workability, and had insufficient coating suitability for the ink layer.

Experimental Example 10 including Oligomer 5, which is a trifunctional epoxy acrylate oligomer, and Experimental Example 13 including Monomer 5, which is a tetrafunctional acrylate monomer, had cracks in the prepared adhesive layer, and also had cracks after 360° folding after storage.

In addition, Experimental Example 11 including Monomer 3, which is a bifunctional acrylate monomer, and Experimental Example 12 including Monomer 4, which is a trifunctional acrylate monomer, had cracks in the prepared adhesive layer. Particularly,

Experimental Example 12 had cracks in the specimen after 360° folding at −20° C. Experimental Example 15 including an excessive amount of a urethane acrylate oligomer and a small amount of a caprolactam-based compound has insufficient peel strength after storage at 60° C. for 2 weeks.

1. A ultraviolet-curable adhesive composition comprising:
a urethane (meth)acrylate-based oligomer, a (meth)acrylate-based monomer, a caprolactam-based compound, and an ultraviolet initiator,
wherein the urethane (meth)acrylate-based oligomer includes two functional groups, and has a weight average molecular weight of 500 g/mol to 2,000 g/mol.

2. The ultraviolet-curable adhesive composition of claim 1, wherein:
the urethane (meth)acrylate-based oligomer has a viscosity at 25° C. of 1,000 cps to 5,000 cps; and
the (meth)acrylate-based monomer has a weight average molecular weight of 100 g/mol to 1,000 g/mol.

3. The ultraviolet-curable adhesive composition of claim 1, wherein the (meth)acrylate-based monomer comprises a first (meth)acrylate-based monomer containing a heterocycle group and a second (meth)acrylate-based monomer containing an aryl group.

4. The ultraviolet-curable adhesive composition of claim 1, wherein the ultraviolet initiator comprises an acyl group-containing phosphine oxide-based compound.

5. The ultraviolet-curable adhesive composition of claim 1, wherein the ultraviolet-curable adhesive composition comprises 25 wt % to 40 wt % of the urethane (meth)acrylate-based oligomer, 40 wt % to 60 wt % of the (meth)acrylate-based monomer, 10 wt % to 20 wt % of the caprolactam-based compound, and 2 wt % to 6 wt % of the ultraviolet initiator.

6. An interior film comprising:
a base layer;
an ink layer formed on the base layer;
an adhesive layer formed on the ink layer, and formed from the ultraviolet-curable adhesive composition of claim 1; and
a transparent protective layer formed on the adhesive layer.
